(19) United States
(12) Patent Application Publication
(10) Pub. No.: US 2012/0120640 A1
(43) Pub. Date: May 17, 2012

(54) Traffic safety system

(76) Inventor: Matthew M. Graham, Chandler, AZ (US)

(21) Appl. No.: 12/927,408

(22) Filed: Nov. 15, 2010

(51) Int. Cl. F21L 4/08

(52) U.S. Cl. 362/183

(57) ABSTRACT

A traffic safety system includes an enhanced reflective strip made from a flat, elongated flexible material having a plurality of layers. Preferably, the enhanced reflective strip includes a back layer having a plurality of LED's arranged in a pattern; a middle layer including weatherproofing material; and a front layer including a reflective material. Preferably, the enhanced reflective strip is installed in place of the top reflective band on a round construction drum or a construction barricade, though it could also be installed on any flat or round surface such as lane dividers, guardrails or water barriers. In a preferred embodiment of the present invention the enhanced reflective strip is installed on a construction drum and is solar powered. Preferably, a thin-film solar panel is attached to the top surface of the construction drum and the other components are placed inside the drum.

### FIELD OF THE INVENTION

The present invention relates to the field of road traffic safety, and, more particularly, to enhancement of roadway warning devices so as to increase motorist alertness to them.

### BACKGROUND

Roadway warning markers such as construction drums and barricades are placed on roadways to warn motorists of the presence of a work zone, dangerous highway conditions, and for various other reasons related to traffic safety. Although such devices are typically brightly colored and include reflective material to make them more visible, motorists sometimes fail to be alerted by them.

Some conventional construction drums and barricades include a large light to provide further visibility. However, the maintenance costs of these devices tend to be high because the bulbs and batteries must be periodically replaced. Furthermore, because the light is rather large and heavy, it can cause injury if it breaks free when hit by a vehicle.

### SUMMARY OF THE INVENTION

A traffic safety system includes an enhanced reflective strip made from a flat, elongated flexible material having a plurality of layers. Preferably, the enhanced reflective strip includes a back layer having a plurality of light emitting diodes (LED's) arranged in a pattern; a middle layer including weatherproofing material; and a front layer including a reflective material. Preferably, the enhanced reflective strip is installed in place of the top reflective band on a round construction drum or a construction barricade, though it could also be installed on any flat or round surface such as lane dividers, guardrails or water barriers.

In a preferred embodiment of the present invention the enhanced reflective strip is installed on a construction drum and is solar powered. Preferably, a thin-film solar panel is attached to the top surface of the construction drum and the other components (e.g., a solar power converter, a controller, and a battery) are placed inside the drum. Notably, this design allows for much lower risk of injury should the construction drum be hit by a vehicle because the inside components would not break away.

Preferably, the enhanced reflective strip can be riveted or adhesively attached to the outside surface of the construction drum. Preferably the LEDs can be operated in steady burn mode or flashing mode. When in flashing mode, the flash rate will be not less than 55 and not more than 75 flashes per minute. In the unlikely event that the LED's fail to operate, the reflective layer will still meet pertinent safety requirements.

Preferably, the thin-film solar panel is electrically connected to the solar power converter situated in the inside portion of the construction drum. Preferably, the solar power converter connects to the controller which itself is connected to the battery, allowing the battery to be recharged. In operation, the LED's are run by the battery power, through the controller which controls the LED's, including, for example, the flash rate.

These and other aspects, features, and advantages of the present invention will become apparent from the following detailed description of preferred embodiments, which is to be read in connection with the accompanying drawings.

### BRIEF DESCRIPTION OF THE DRAWINGS

FIG. 1 illustrates an exemplary construction drum configured in accordance with the present invention;

FIG. 2 illustrates a close-up view of the upper portion of the construction drum;

FIG. 3 illustrates the enhanced reflective strip;

FIG. 4 illustrates the individual layers of the enhanced reflective strip;

FIG. 5 illustrates the connections among the enhanced reflective strip and the other components of the present invention;

FIG. 6 illustrates the preferred embodiment of the present invention in which the enhanced reflective strip is installed on the construction drum and is solar-powered; and

FIGS. 7 and 8 illustrate the various components mounted on the inside of the construction drum.

### DETAILED DESCRIPTION

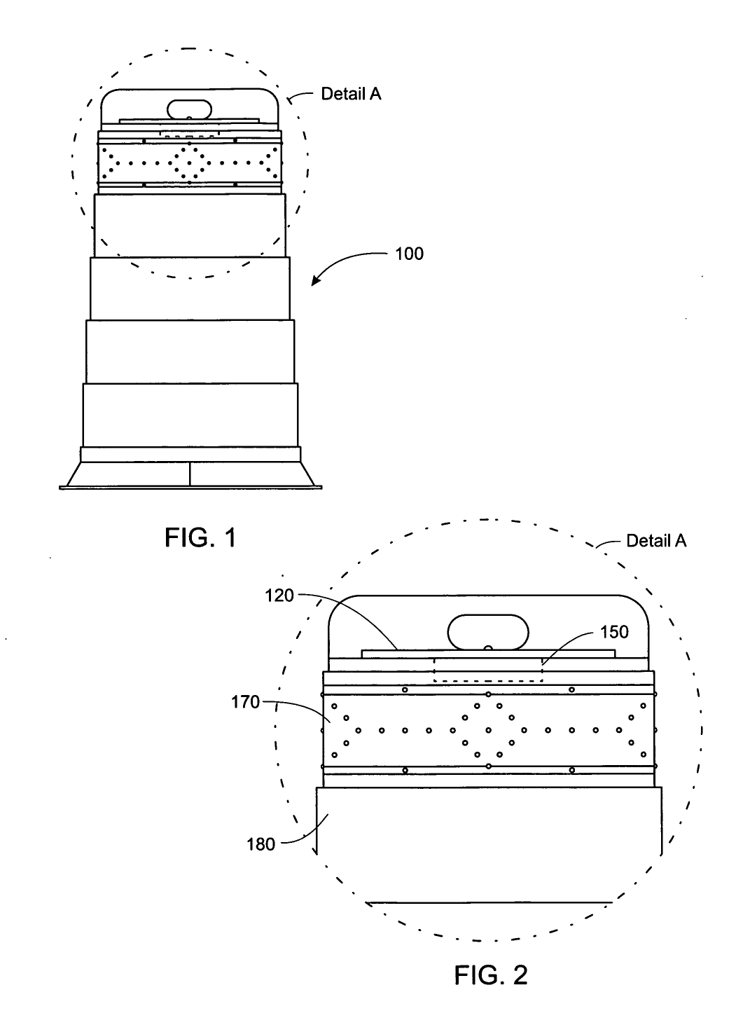

FIG. 1 illustrates an exemplary construction drum 100 configured in accordance with the present invention. FIG. 2 illustrates a close-up view (Detail A) of the upper portion of the construction drum 100. As depicted in FIG. 2, an enhanced reflective strip 170 is shown installed on an outer surface 180 of the construction drum 100. As will be described in greater detail, the enhanced reflective strip 170 includes a back layer having a plurality of LED's arranged in a pattern; a middle layer including weatherproofing material; and a front layer including a reflective material. In the preferred embodiment of the present invention, the enhanced reflective strip 170 is installed on the construction drum 100 and is powered by solar energy (with back-up battery). Preferably, a thin-film solar panel 120 is attached to the top surface of the construction drum 100 and the inside components 150 (e.g., a solar power converter, a controller, and the battery) are placed inside the construction drum 100. Notably, this design allows for much lower risk of injury should the construction drum 100 be hit by a vehicle because the inside components 150 would not break away.

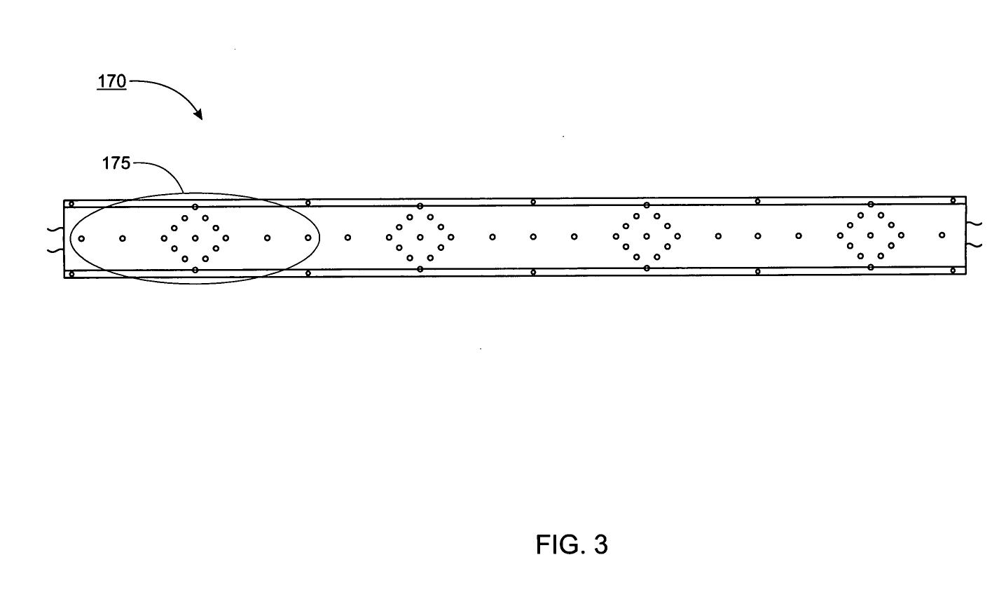

FIG. 3 illustrates the enhanced reflective strip 170. As shown in FIG. 3, the enhanced reflective strip 170 includes a plurality of LED's arranged in a pattern 175. Preferably, the pattern chosen will be a repeating pattern that is likely to alert motorists. The enhanced reflective strip 170 is, preferably, between about 4 inches and about 6 inches in width. The length of the enhanced reflective strip 170 varies depending on the item to be covered. Although the preferred embodiment of the present invention involves installation of the enhanced reflective strip on a construction drum 100, it is to be appreciated that the enhanced reflective strip 170 could be installed on any flat or round surface such as construction barricades, lane dividers, guardrails, and water barriers, etc.

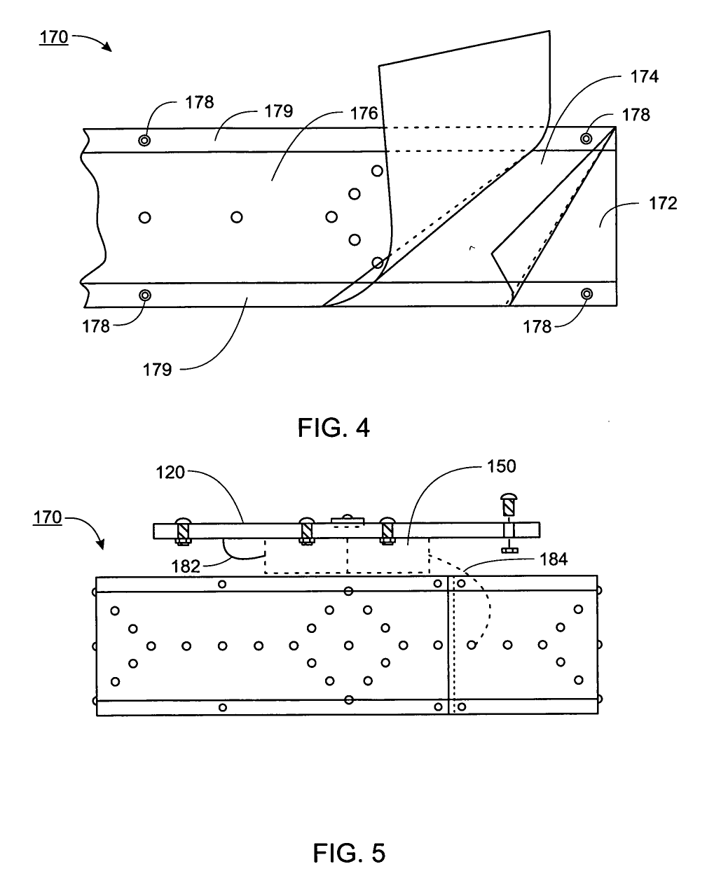

FIG. 4 illustrates the individual layers of the enhanced reflective strip 170. As shown, the enhanced reflective strip 170 includes a back layer 172 having a plurality of LED's arranged in a pattern; a middle layer 174 including weatherproofing material; and a front layer 176 including a reflective material. Preferably, the LED's on the back layer 172 are amber colored and are arranged in series. Suitable LED strips useable for the present invention include certain of those made by Kingbright Corporation, headquartered in Taiwan. Preferably, the waterproofing material on the middle layer 174 includes suitable clear, plastic sheeting capable of repelling water, snow, and ice, as well as dirt and dust. Preferably, the reflective material on the front layer 176 includes high-intensity prismatic sheeting, such as, for example the 3930 series of high-intensive prismatic sheeting made by 3M Corporation, based in Maplewood, Minn. Additionally, the enhanced reflective strip 170 can include rivet holes 178 useable for riveting the enhanced reflective strip 170 to the construction drum 100. Alternatively, the enhanced reflective strip 170 could be adhesively attached to the construction drum 100. In the latter case, the rivet holes 178 would be an optional feature, and the enhanced reflective strip 170 would, preferably, include a pressure-sensitive adhesive backing, so as to facilitate installation of the enhanced reflective 170 strip onto the outer surface 180 of the construction drum 100. Furthermore, preferably, the enhanced reflective strip 170 includes binded edges 179, as shown. The binded edges 179 hold the back layer 172, the middle layer 174, and the front layer 176 together, to create a unitary piece.

FIG. 5 illustrates the connections among the enhanced reflective strip 170 and the other components of the present invention. Preferably, the inside components 150 can be mounted to the inside portion of the construction drum 100 using a plurality of rivets 178 that are driven through the top portion of the construction drum 100, to hold the inside components 180, preferably, by attachment using a mounting bracket (not shown). However, the inside components 150 could, alternatively, be installed using other methods such as, for example, by adhesive attachment (e.g., epoxy). As shown, an electrical connector 182 electrically connects components on the outside surface 180 (e.g., the thin-film solar panel 120) with the inside components 150. Preferably, this electrical connector 182 passes through a hole in the outside surface 180, reaching the inside components 150. Similarly, an electrical connector 184 electrically connects the inside components 150 with the enhanced reflective strip 170, passing through the construction drum 100 via another such hole.

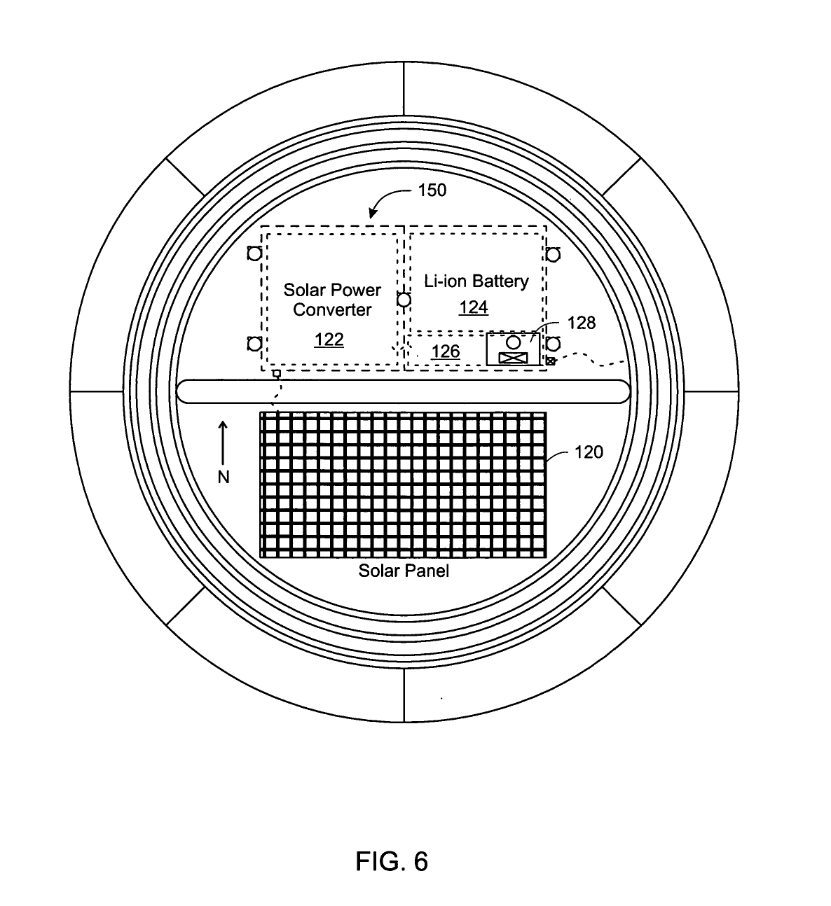

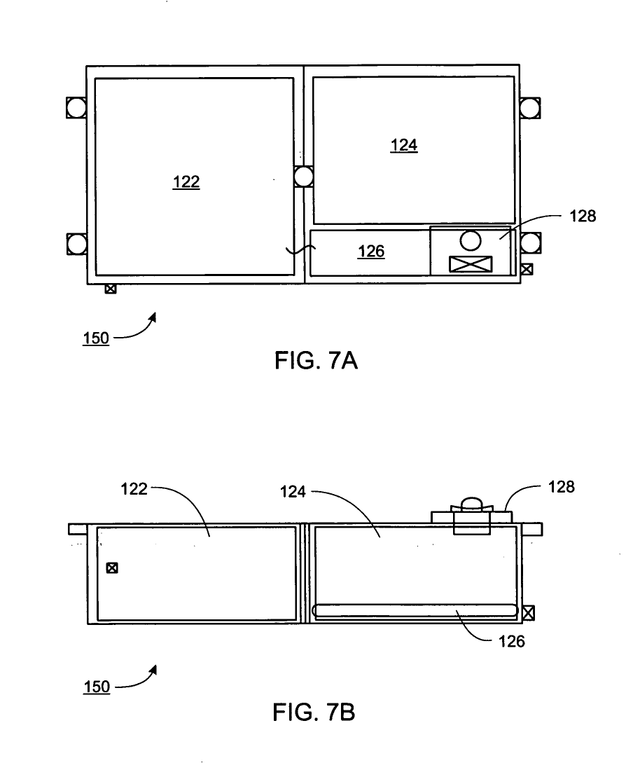

FIG. 6 illustrates the preferred embodiment of the present invention in which the enhanced reflective strip 170 is installed on the construction drum 100 and is solar-powered. FIGS. 7 and 8 illustrate the inside components 150 mounted on the inside of the construction drum 100. As shown in FIG. 6, the thin-film solar panel 120 is installed on a top portion of the construction drum 100. On the inside of the construction drum 100 are a solar power converter 122 (useable for converting the electrical energy from the solar arrays to a stable and reliable power source); a battery 124 (preferably, lithium ion), and a controller 126 (useable for controlling operation of the LED's).

Preferably, the thin-film solar panel 120 is electrically connected to the solar power converter 122. Preferably, the solar power converter 122 is electrically connected to the controller 126, which itself is electrically connected to the battery 124, allowing the battery 124 to be recharged. In operation, the LED's on the enhanced reflective strip 170 are run by the battery 124, through the controller 122 which controls the LED's, including, for example, the flash rate. Preferably the LEDs can be operated in steady burn mode or flashing mode. When in flashing mode, the flash rate will be not less than 55 and not more than 75 flashes per minute. In the unlikely event that the LED's fail to operate, the reflectivity from the reflective material on the front layer 176 will still meet pertinent safety requirements. Preferably, a light-sensitive automatic on/off switch 128 is also provided to conserve energy by powering off the device when lighting is not needed.

Advantageously, the preferred embodiment of the present invention described herein meets all Manual of Uniform Traffic Control Devices (MUTCD) standards, promulgated by the U.S. Department of Transportation.

In various preferred embodiments of the present invention, a construction drum 100 can be retrofitted in accordance with the present invention. A retrofitting kit can include all of the components of the invention, mounting equipment, and, preferably, a set of instructions.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A traffic safety system, comprising:
an enhanced reflective strip, the enhanced reflective strip including a flat, elongated flexible material having a plurality of layers, wherein one of the layers includes a series of lights arranged in a pattern, the lights visible to a driver when the enhanced reflective strip is attached to a roadway object; and
a power source, the power source including a solar power source.

2. The traffic safety system of claim 1, wherein the series of lights is a strip of light emitting diodes (LED).

3. The traffic safety system of claim 2, further comprising a construction drum, the enhanced reflective strip attached to an outer surface of the construction drum and the power source including a thin-film solar panel and a solar power converter, the thin-film solar panel attached to an outside portion of the construction drum and the solar powered converter attached to an inside portion of the construction drum.

4. The traffic safety system of claim 3, wherein the power source further includes a removable, re-chargeable back-up battery pack attached to the inside portion of the construction drum.

5. The traffic safety system of claim 3, wherein the enhanced reflective strip is riveted to the construction drum.

6. The traffic safety system of claim 3, wherein the enhanced reflective strip is adhesively attached to the construction drum.

7. The traffic safety system of claim 1, wherein another one of the layers includes a reflective material, the reflective material including high-intensity prismatic sheeting.

8. The traffic safety system of claim 1, wherein another one of the layers includes weatherproofing material.

9. The traffic safety system of claim 3, further comprising a controller attached to the inside portion of the construction drum to control operation of the traffic safety system.

10. The traffic safety system of claim 1, wherein the enhanced reflective strips are between about 4 inches and 6 inches in width.

11. The traffic safety system of claim 3, wherein the traffic safety system meets all Manual of Uniform Traffic Control Devices (MUTCD) standards, as of the filing date of the present patent application.

12. The traffic safety system of claim 1, wherein the lights are capable of being in either steady burn mode or flashing mode.

13. The traffic safety system of claim 13, wherein, when in the flashing mode, flash rate is not less than 55 and not more than 75 flashes per minute.

14. The traffic safety system of claim 1, further including a light-sensitive automatic on/off switch.

15. A kit, comprising:
an enhanced reflective strip;
a thin-film solar panel;
a solar power converter;
a controller/battery box; and
mounting equipment;
wherein the enhanced reflective strip includes a flat, elongated flexible material having a plurality of layers, wherein one of the plurality of layers includes a series of LEDs arranged in a pattern.

16. The kit of claim 15,
wherein the kit can be used to retrofit a construction drum by:
attaching the enhanced reflective strip to an outer side portion of the construction drum;
attaching the thin-film solar panel a top outside portion of the construction drum; and
using the mounting equipment to:
attach the solar power converter and the controller/battery box to an inside portion of the construction drum.

17. The kit of claim 15, wherein the enhanced reflective strip is riveted or adhesively attached to the construction drum.

18. The kit of claim 15, wherein another one of the layers includes a reflective material, the reflective material including high-intensity prismatic sheeting.

19. The kit of claim 15, wherein another one of the layers includes weatherproofing material.

20. The of claim 15, wherein a construction drum retrofitted using the kit meets all Manual of Uniform Traffic Control Devices (MUTCD) standards, as of the filing date of the present patent application.
